(19) United States
(12) Patent Application Publication
(10) Pub. No.: US 2008/0244012 A1
(43) Pub. Date: Oct. 2, 2008

(54) INSTANT MESSAGING WITH REDUCED MESSAGE OVERHEAD

(75) Inventors: AMIR KLEKS, HOD-HASHARON (IL); YAKI KUPHERSTEIN, KIBBUTZ REVADIM (IL)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, ARMONK, NY (US)

(21) Appl. No.: 11/693,847

(22) Filed: Mar. 30, 2007

(51) Int. Cl. G06F 15/16

(52) U.S. Cl. 709/206

(57) ABSTRACT

A messaging system with reduced overhead, the system including a messaging server operative to receive a typing message sent from the first computer and destined for a second computer, and a message filter operative to determine a level of unused resources of the server, and instruct the server to forward the typing message to the second computer only if the level is within predefined parameters.

### FIELD OF THE INVENTION

The present invention relates to instant messaging in general, and more particularly to improving efficiency and reducing load when communicating via an instant messaging server.

### BACKGROUND OF THE INVENTION

Instant Messaging (IM) is becoming an increasingly popular form of communication, combining the real-time efficiency of a phone call with the non-invasive aspects of email. With so many companies offering IM services that use different protocols, there has been a need to create gateways that translate IM messages from one protocol to another to enable users of different IM systems to communicate with each other.

One popular feature of IM systems enables each party in an IM conversation to receive a real-time notification indicating that the other party is typing a message. This notification is referred to herein as a “typing message”. FIG. 1 is a block-flow diagram of a typical IM gateway in which two computers 100 and 104 are each configured with an IM client and exchange messages via a gateway 102. As a message is typed within the IM client at computer 100, computer 100 sends to gateway 102 a typing message destined for computer 104. Gateway 102 receives the typing message, translates it, if necessary, to the appropriate protocol used by computer 104, and sends it to computer 104. Upon receiving the typing message, computer 104 sends an acknowledgement to gateway 102 acknowledging receipt of the typing message. Gateway 102 receives the acknowledgement, translates it if necessary, to the appropriate protocol used by computer 100, and sends it to computer 100. While the processing and bandwidth overhead involved in sending and receiving such messages is typically manageable when IM conversations are conducted using the same protocol, the overhead is far greater when the messages must be translated from one protocol to another and often taxes IM gateways.

### SUMMARY OF THE INVENTION

The present invention in embodiments thereof discloses novel systems and methods for instant messaging with reduced message overhead.

In one aspect of the present invention a messaging system with reduced overhead is provided, the system including a messaging server operative to receive a typing message sent from a first computer and destined for a second computer, and a message filter operative to determine a level of unused resources of the server, and instruct the server to forward the typing message to the second computer only if the level is within predefined parameters.

In another aspect of the present invention a method is provided for reducing overhead in a messaging system, the method including receiving a typing message sent from a first computer and destined for a second computer, determining a level of unused resources of a server, and instructing the server to forward the typing message to the second computer only if the level is within predefined parameters.

In another aspect of the present invention a computer program is provided embodied on a computer-readable medium, the computer program including a first code segment operative to receive a typing message sent from a first computer and destined for a second computer, and a second code segment operative to determine a level of unused resources of the server, and instruct the server to forward the typing message to the second computer only if the level is within predefined parameters.

### BRIEF DESCRIPTION OF THE DRAWINGS

The present invention will be understood and appreciated more fully from the following detailed description taken in conjunction with the appended drawings in which:

FIG. 1 is a block-flow diagram of an IM gateway, useful in understanding the present invention;

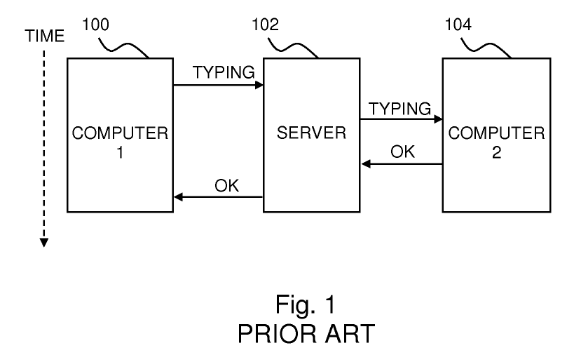

FIGS. 2A and 2B are simplified conceptual illustrations of an IM system with reduced message overhead, constructed and operative in accordance with an embodiment of the present invention;

FIG. 3 is a simplified conceptual illustration of an IM system with reduced message overhead, constructed and operative in accordance with another embodiment of the present invention; and

FIG. 4 is a simplified flowchart illustration of an exemplary method of operation of the system of FIGS. 2A and 2B, operative in accordance with an embodiment of the present invention.

### DETAILED DESCRIPTION OF THE INVENTION

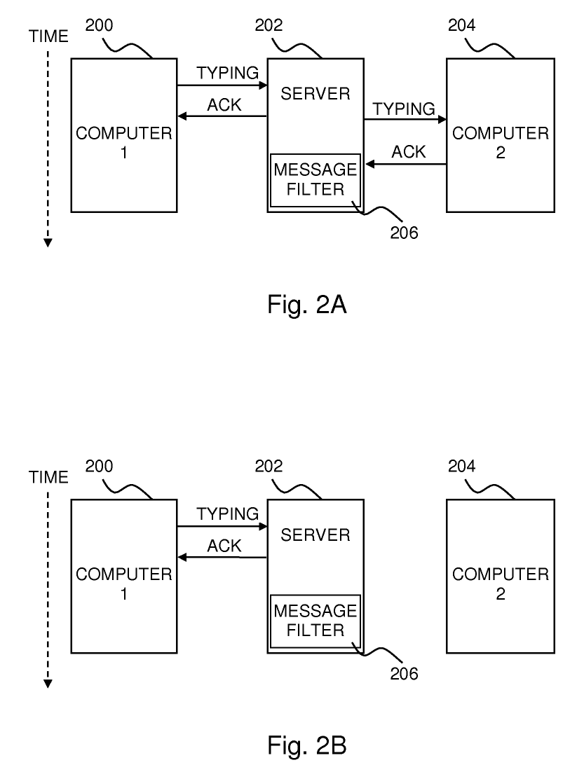

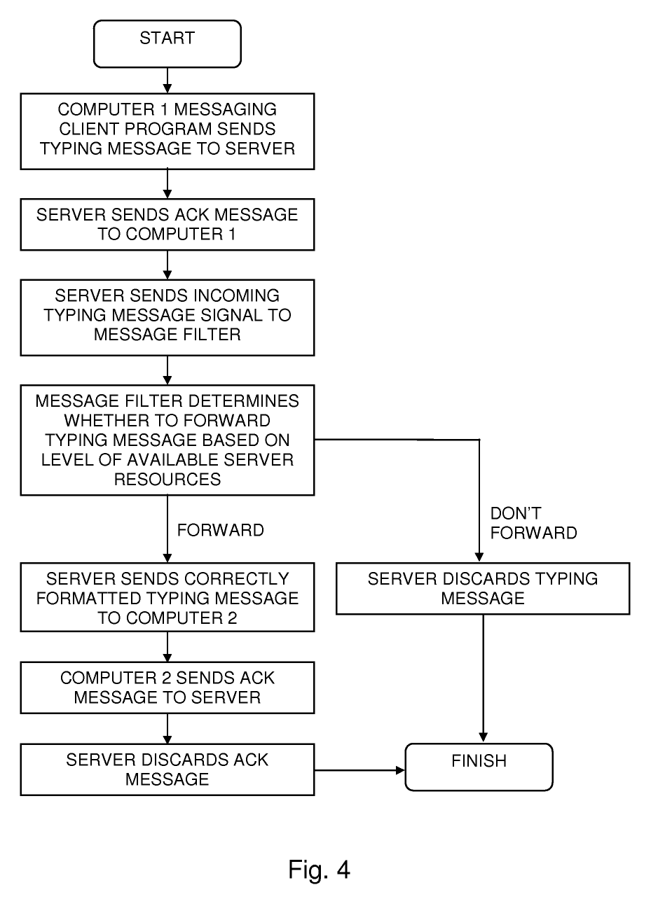

Reference is now made to FIGS. 2A and 2B, which are simplified conceptual illustrations of an IM system with reduced overhead, constructed and operative in accordance with an embodiment of the present invention, and additionally to FIG. 4, which is a simplified flowchart illustration of an exemplary method of operation of the system of FIGS. 2A and 2B, operative in accordance with an embodiment of the present invention.

The system of FIGS. 2A and 2B may be appreciated in the context of the following exemplary operational scenario in which a computer 200 includes an IM client which engages in an IM conversation with another IM client currently running on computer 204. All IM messages between computers 200 and 204 are sent via a server 202, which may relay IM messages as is, or may act as a gateway and translate IM messages from one protocol to another. As a message is typed within the IM client at computer 200, computer 200 sends to server 202 a typing message that is destined for computer 204, where the typing message sent by computer 200 is formatted according to the IM protocol of computer 200. Server 202 synthesizes an acknowledgement message that computer 200 expects to receive from computer 204 and sends it back to computer 200. Server 202 then notifies a message filter 206 that a typing message was received from computer 200, or, alternatively, message filter 206 otherwise detects the arrival of the typing message. Message filter 206, which may be configured with server 202 or may be external to server 202, determines the level of unused resources of server 202, such as the current unused processing capacity and/or the current unused bandwidth capacity of server 202, in accordance with conventional techniques. If the level is within predefined parameters, such as is seen in FIG. 2A, message filter 206 instructs server 202 to translate and/or forward the typing message to computer 204. Server 202 then translates the typing message to the IM protocol of computer 204 if it is different than the IM protocol of computer 200 and forwards the typing message to computer 204. Computer 204 then replies by sending an acknowledgement message to server 202, upon which server 202 preferably does not act. If the level is not within predefined parameters, such as is seen in FIG. 2B, message filter 206 instructs server 202 not to translate or forward the typing message to computer 204.

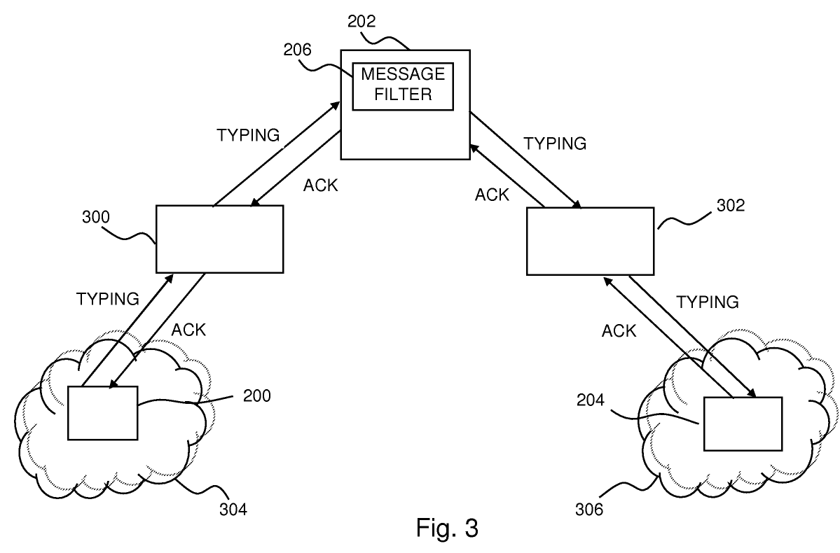

Reference is now made to FIG. 3 which is a simplified conceptual illustration of an IM system with reduced overhead, constructed and operative in accordance with another embodiment of the present invention. The system of FIG. 3 is substantially similar to the system of FIGS. 2A and 2B with the notable exception that computer 200 may belong to a network of computers 304 connected to a server 300, and computer 204 may belong to a network of computers 306 connected to a server 302. Servers 300 and 302 communicate with each other via server 202. Computers belonging to network 304 and connected to server 300 typically use one IM protocol and computers belonging to network 306 and connected to server 300 typically use a different IM protocol. Alternatively, both network 304 connected to server 300 and network 306 connected to server 302 may operate under the same IM protocol.

The system of FIG. 3 may be appreciated in the context of the following exemplary operational scenario in which computer 200 sends to server 300 a typing message destined for computer 204. Server 300 sends the message to server 202. Server 202 synthesizes an acknowledgement message that computer 200 expects to receive from computer 204 and sends it to server 300. Server 300 then sends the acknowledgement to computer 200. Message filter 206 then determines whether or not to forward the typing message, as described above for FIGS. 2A and 2B. If the message is to be forwarded, message filter 206 instructs server 202 to translate and/or forward the typing message to server 302. Server 202 then translates the typing message if necessary and forwards the typing message with the appropriate protocol to server 302, whereupon server 302 forwards the typing message to computer 204. Computer 204 then replies by sending an acknowledgement destined for computer 200 to server 302. Server 302 forwards the acknowledgment to server 202 upon which server 202 preferably does not act. If the message is not to be forwarded, message filter 206 instructs server 202 not to translate or forward the typing message to server 302.

It will be appreciated that by providing an IM server with a message filter, the present invention offers a greater degree of efficiency under high traffic conditions while still maintaining a satisfactory user experience.

While the methods and apparatus herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A messaging system with reduced overhead, the system comprising:
a messaging server operative to receive a typing message sent from a first computer and destined for a second computer; and
a message filter operative to
determine a level of unused resources of said server, and
instruct said server to forward said typing message to said second computer only if said level is within predefined parameters.

2. The system according to claim 1 wherein said server is operative to act as a gateway between said computers and translate any of said messages between a first protocol and a second protocol.

3. The system according to claim 2 wherein said message filter is operative to instruct said server to translate said typing message between said first protocol and said second protocol prior to forwarding said typing message to said second computer.

4. The system according to claim 1 wherein said level of unused resources is any of the current unused processing capacity and the current unused bandwidth capacity of said server.

5. The system according to claim 1 wherein said server is operative to
synthesize a acknowledgement message acknowledging receipt of said message by said said second computer, and
send said acknowledgement message to said first computer.

6. The system according to claim 1 and further comprising:
a first network server operative to relay messages between said first computer and said messaging server; and
a second network server operative to relay messages between said second computer and said messaging server.

7. A method for reducing overhead in a messaging system, the method comprising:
receiving a typing message sent from a first computer and destined for a second computer;
determining a level of unused resources of a server; and
instructing said server to forward said typing message to said second computer only if said level is within predefined parameters.

8. The method according to claim 7 and further comprising translating any of said messages between a first protocol and a second protocol.

9. The method according to claim 8 wherein said instructing step comprises instructing said server to translate said typing message between said first protocol and said second protocol prior to forwarding said typing message to said second computer.

10. The method according to claim 7 wherein said determining step comprises determining said level of unused resources as any of the current unused processing capacity and the current unused bandwidth capacity of said server.

11. The method according to claim 7 and further comprising:
synthesizing a acknowledgement message acknowledging receipt of said message by said said second computer; and
sending said acknowledgement message to said first computer.

12. A computer program embodied on a computer-readable medium, the computer program comprising:
a first code segment operative to receive a typing message sent from a first computer and destined for a second computer; and
a second code segment operative to
determine a level of unused resources of said server, and
instruct said server to forward said typing message to said second computer only if said level is within predefined parameters.
